(19) United States
(12) Patent Application Publication
(10) Pub. No.: US 2007/0245917 A1
(43) Pub. Date: Oct. 25, 2007

(54) WEB DETECTION DEVICE OF PRINTING PRESS

(75) Inventors: Motoyasu Suzuki, Noda-Shi (JP); Katsuharu Miyazaki, Noda-Shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/736,966

(22) Filed: Apr. 18, 2007

(30) Foreign Application Priority Data
Apr. 19, 2006 (JP) 2006-115212
Mar. 5, 2007 (JP) 2007-053848

(51) Int. Cl. B41F 35/00

(52) U.S. Cl. 101/424.1

(57) ABSTRACT

Provided is a web detection device of a printing press capable of promptly detecting paper breakage, the web detection device being provided with: a printing unit which prints on a web being transported; a dryer, which is provided on the downstream side in the web transporting direction of the printing unit, and which dries the printed web; a chill roller, which is provided on the downstream side in the web transporting direction of the dryer, and around which the dried web is wound; and a detection device, which is provided in a vicinity of the chill roller, and which detects that the position in a web surface crossing direction of a web having been cut exceeds a predetermined allowable range.

### BACKGROUND OF THE INVENTION

1. Field of the Invention

The present invention relates to a web detection device of a printing press, which detects paper breakage of a web being transported.

2. Description of the Related Art

Generally, in a printing press such as a web rotary printing press, printing is made while a web (continuous paper) is continuously transported. Accordingly, paper breakage often occurs during printing due to a change in the tension of the web, or other troubles. In a case where such paper breakage occurs, the web which has been cut is slacked, and then is wound multiple times around a circumferential surface, of a blanket cylinder or a plate cylinder of a printing unit, or of a roller of an inking device. Such a cut web being wound therearound not only seriously damages the cylinder or the roller, but also may damage the printing press itself. For this reason, a conventional printing press is provided with a web detection device which prevents such a cut web from being wound around a cylinder or a roller by detecting the cut web.

In this web detection device, a predetermined allowable range in a web surface crossing direction (upper and lower directions) of a web being transported is set. When detecting that the cut web goes out of this predetermined allowable range, the web detection device stops the operation of a printing press. Such a conventional printing press is disclosed in Japanese Patent Publication No. 3352145.

In a conventional web detection device, a web, which has been cut in a dryer, is detected on the upstream side in the web transporting direction of the dryer. However, as in the conventional manner, in a case where the cut web is detected on the upstream side in the web transporting direction of the position where the web has been cut, the web detection device detects the cut web, which has lost tension. This makes it very difficult to grasp the behavior of the web since the web has already been cut, and the behavior thereof is unstable. Furthermore, this situation also leads to reduction in detection accuracy. Accordingly, in the conventional web detection device, since the behavior of the cut web sometimes makes the detection of the paper breakage require a longer time, it is difficult to prevent the cut web from being wound around a cylinder or a roller.

Furthermore, it is conceivable to reduce the allowable range in order to detect paper breakage by the web detection device in a shorter period of time. However, a web being transported in the dryer particularly vibrates with a large amplitude in the web surface crossing direction due to the blowing of hot air. Since this amplitude changes depending on a printing condition such as a printing speed, it is necessary to set the allowable range with a margin to some extent. Specifically, when paper breakage is to be detected while reducing the allowable range, paper breakage, which is actually not occurring, may be wrongly detected. Accordingly, in order to prevent damage from occurring due to the winding of cut web, stable and prompt detection of paper breakage has been sought in recent years while the speed of printing press has been improved.

### SUMMARY OF THE INVENTION

Accordingly, the present invention aims to solve the aforementioned problems, and provides a web detection device of a printing press which can detect paper breakage promptly.

In order to solve the aforementioned problems, a web detection device of a printing press according to a first aspect of the present invention provides the following characteristics. The web detection device includes a printing unit, drying means, a rotating part’ and detection means. The printing unit prints on a web being transported. The drying means is provided on a downstream side in a web transporting direction of the printing unit, and dries the printed web. The rotating part is provided on a downstream side in the web transporting direction of the drying means, and the dried web is wound around the rotating part. The detection means is provided in a vicinity of the rotating part, and detects that a position of a web in a web surface crossing direction exceeds an allowable range.

In order to solve the aforementioned problems, the web detection device of a printing press according to a second aspect of the present invention provides the following characteristics. The web detection device further includes blowing means, in the web detection device of a printing press according to the first aspect. The blowing means is provided in a vicinity of the detection means, and which always blows air to a web being transported.

In order to solve the aforementioned problems, the web detection device of a printing press according a third aspect of the present invention provides the following characteristics. The web detection device includes the blowing means, in the web detection device of a printing press according to the second aspect of the invention. The blowing means is provided above the web being transported.

In order to solve the aforementioned problems, the web detection device of a printing press according a fourth aspect of the present invention provides the following characteristics. The web detection device includes the detection means which is provided below the web being transported, in the web detection device of a printing press according to the third aspect of the invention.

In order to solve the aforementioned problems, the web detection device of a printing press according a fifth aspect of the present invention provides the following characteristics. The web detection device further includes discharge means, in the web detection device of a printing press according to the first aspect of the invention. The discharge means is provided between the printing unit and the drying means. In addition, the discharge means discharges a part of the web being transported from the printing unit to the drying means side in a direction different from a direction towards the drying means side when the detection means detects that the web has exceeded the allowable range.

In order to solve the aforementioned problems, the web detection device of a printing press according a sixth aspect of the present invention provides the following characteristics. The web detection device further includes discharge means, in the web detection device of a printing press according to the first aspect of the invention. The discharge means is provided between the printing unit and the drying means. In addition, the discharge means pulls out a part of the web from the printing unit when the detection means detects that the web has exceeded the allowable range.

In order to solve the aforementioned problems, the web detection device of a printing press according a seventh aspect of the present invention provides the following characteristics. The web detection device includes the discharge means including: a drive roller, which is provided on one side of the web being transported, and which is rotationally driven; and a moving roller, which is capable of moving in an area between a position at another side of the web being transported and a position at which the moving roller comes into contact with the driving roller with the web interposed therebetween, in the web detection device of a printing press according to any one of the fifth and sixth aspects of the invention. In addition, the web detection device of a printing press according the seventh aspect of the present invention includes the discharge means which causes the movable roller to move so that the moving roller comes into contact with the drive roller with the web interposed therebetween when the detection means detects that the web exceeds the allowable range.

In order to solve the aforementioned problems, the web detection device of a printing press according an eighth aspect of the present invention provides the following characteristics. The web detection device includes the drive roller provided below the web being transported, and the moving roller provided above the web being transported, in the web detection device of a printing press according to the seventh aspect of the invention.

In order to solve the aforementioned problems, the web detection device of a printing press according a ninth aspect of the present invention provides the following characteristics. The web detection device includes the rotating part which is a roller configured to be rotationally driven, and to provide tension to a web being transported, in the web detection device of a printing press according to the first aspect of the invention.

In order to solve the aforementioned problems, the web detection device of a printing press according a tenth aspect of the present invention provides the following characteristics. The web detection device includes the rotating part which is a chill roller configured to cool the web dried by the drying means, in the web detection device of a printing press according to the first aspect of the invention.

According to the web detection device of the printing press of the present invention, tension can be provided to a web by the rotating part. Accordingly, the amplitude in the web surface crossing direction of the web can be extremely reduced. In addition, the web having the smaller amplitude is detected by the web detection device. Accordingly, the allowable range in the web surface crossing direction of the web being transported can be small. As a result of this, paper breakage of the web can be promptly detected. Furthermore, even though the allowable range of the detection means is reduced, it is possible to prevent a web which has not been cut from being wrongly detected as a cut web. Moreover, it is possible to set a web which has been cut to exceed the allowable range of the detection device earlier. This makes it possible to prevent the web which has been cut from being wound around the circumferential surface, of the blanket cylinder or the plate cylinder of a printing unit, or of the roller of an inking device.

### BRIEF DESCRIPTION OF THE DRAWINGS

The present invention will become more fully understood from the detailed description given hereinbelow and the accompanying drawings which are given by way of illustration only, and thus are not limitation of the present invention, and wherein:

FIG. 1 is a schematic configuration diagram of a web rotary printing press including a web detection device of a printing press according to an embodiment of the present invention;

FIG. 2 is a schematic configuration diagram of a discharge device; and

FIG. 3 is a schematic configuration diagram of the web detection device of a printing press according to the embodiment of the present invention.

### DETAILED DESCRIPTION OF THE INVENTION

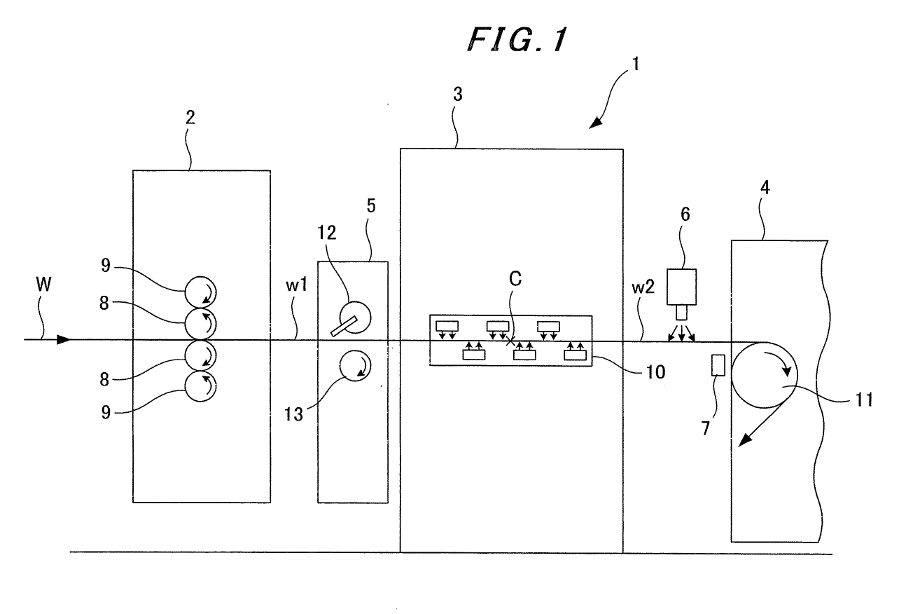

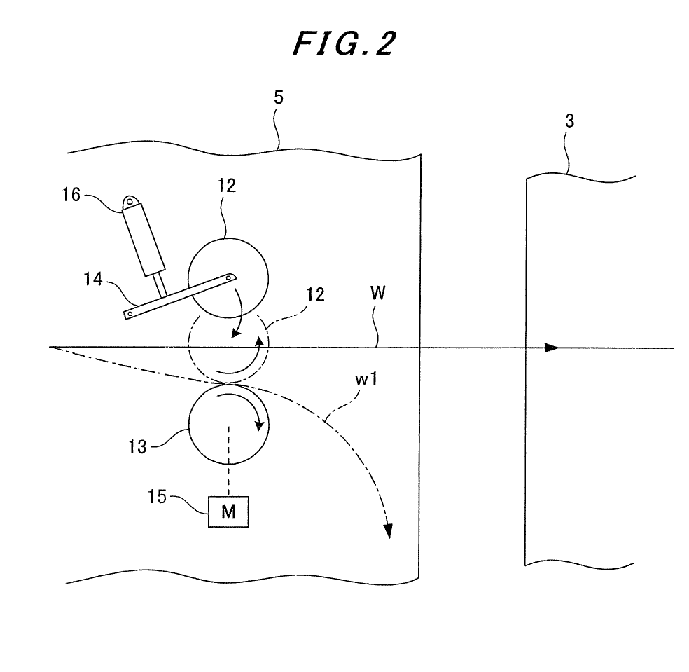

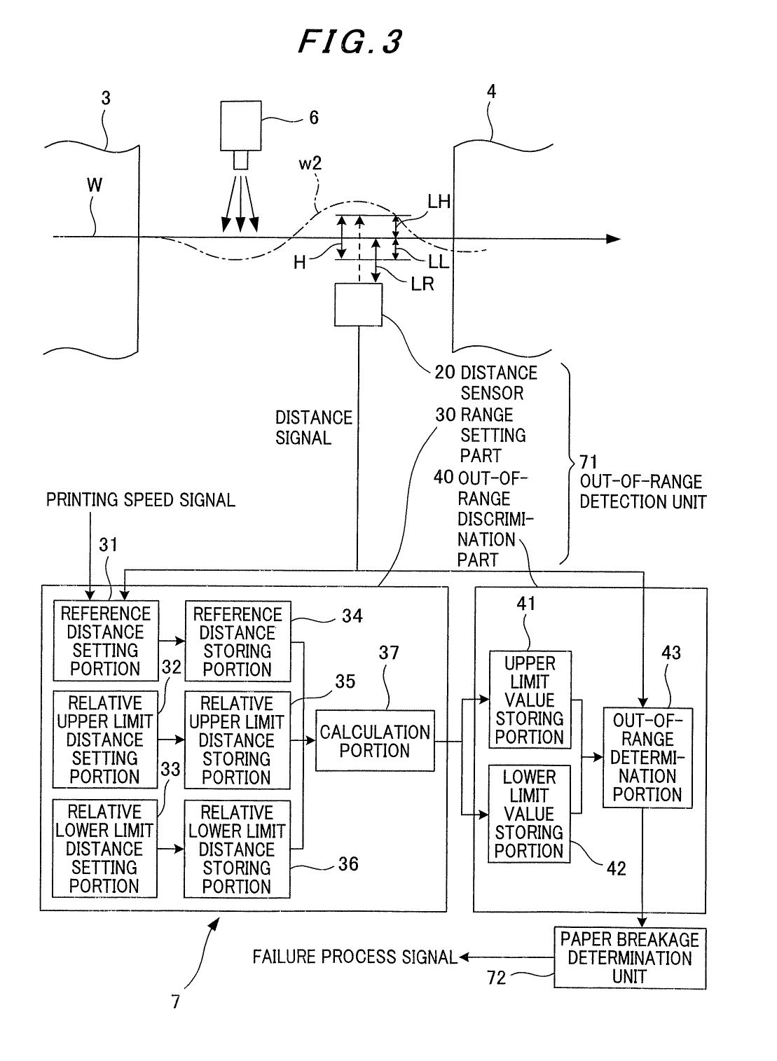

Hereinafter, a web detection device of a printing press according to the present invention will be explained in detail with reference to the drawings. FIG. 1 is a schematic configuration diagram of a web rotary printing press including a web detection device of a printing press according to an embodiment of the present invention. FIG. 2 is a schematic configuration diagram of a discharge device. FIG. 3 is a schematic configuration diagram of the web detection device of the printing press according to the embodiment of the present invention.

As shown in FIG. 1, a printing unit 2, a dryer (drying means) 3, and a cooling device (cooling means) 4 are arranged in a web rotary printing press 1, sequentially in the order named from the upstream side of a transporting direction of a web (continuous paper) W being transported. In addition, a discharge device (discharge means) 5 is provided between the printing unit 2 and the dryer 3. Moreover, an air blowing device (blowing means) 6 and a detection device (detection means) 7 are arranged sequentially in the order named from the upstream side of the transporting direction of a web between the dryer 3 and the cooling device 4.

A pair of upper and lower blanket cylinders 8, and a pair of upper and lower plate cylinders 9 are provided in a rotatable manner in the printing unit 2. The pair of upper and lower plate cylinders 9 are arranged in such a manner that the upper and lower plate cylinders 9 sandwich the pair of upper and lower blanket cylinders 8 in the upper and lower directions. The printing unit 2 can perform printing on both surfaces of the web W by allowing the web W being transported to pass through between the blanket cylinders 8.

A drying portion 10 is provided in the dryer 3. The dryer 3 causes the web W on which printing has been made by the printing unit 2 to pass through the drying portion 10, and then, allows the ink on the sheet of the web W to be dried by blowing air of high temperature thereto from the upper and lower directions of the web W.

Chill rollers (rotating parts) 11, which are driven and then rotate, are provided in the cooling device 4. Cooling water circulates in these chill rollers 11. That is, in the cooling device 4, the web W can be cooled while tension is provided to the web W, by causing the web W which is kept under high temperature environment by the dryer 3 to be wound around the plurality of chill rollers 11 (only one of the chill rollers 11 is shown in FIG. 1).

As shown in FIGS. 1 and 2, a moving roller 12 and a drive roller 13 are provided in the discharge device 5. The moving roller 12 is rotatably supported by the top end of a swing arm 14 in an area above the web W being transported. An air cylinder 16, which causes the swing arm 14 to swing around the base end thereof as the center, is connected to the swing arm 14. In the meantime, the drive roller 13 is rotatably supported in an area below the web W being transported. The drive roller 13 is configured to be rotationally driven in a clock-wise direction by driving a motor 15 which is connected thereto.

Specifically, the moving roller 12 is allowed to move in the upper and lower directions with the swing arm 14 by the operations of the air cylinder 16. The moving roller 12 is configured to be movable to a position above the web W being transported when the air cylinder 16 contracts, and to a position where the moving roller 12 contacts with the drive roller 13 with the web W interposed therebetween when the air cylinder 16 extends.

Accordingly, during normal operations, the motor 15 is driven together with a drive motor for the printing press (omitted from the drawings), which drives the web rotary printing press 1, and the drive roller 13 rotates in association with the driving of this motor 15. At this time, as indicated by the solid lines in FIG. 2, the moving roller 12 is positioned above the web W being transported while being apart from the drive roller 13. Accordingly, since the moving roller 12 and the drive roller 13 do not contact with the web W, the web W is transported into the dryer 3.

Although detailed descriptions are given later, when paper breakage of the web W occurs in the dryer 3, a failure process signal is transmitted from a paper breakage determination unit 72 of the detection device 7 to the air cylinder 16. Subsequently, the air cylinder 16 causes the moving roller 12 to move downward with the swing arm 14, and then to come into contact with the driving roller 13 with the web W interposed therebetween. Thereby, as indicated by the dashed dotted lines, the web W is discharged in a direction to the outside of the dryer 3 (the direction below the discharge device 5 in FIG. 2) which is different from a direction towards the dryer 3. Then, the web W is forcibly pulled out from the printing unit 2.

Furthermore, the air blowing device 6 is arranged above the web W being transported. The air blowing device 6 is configured to always blow air from its nozzle to the web W. It should be noted that the air to be blown from the air blowing device 6 is set to have an amount of pressure which does not provide an influence on the transporting of the web W.

Next, a configuration of the detection device 7 will be explained using FIG. 3.

As shown in FIG. 3, the detection device 7 is arranged below the web W being transported. The detection device 7 is a device configured to grasp that a transporting position of the web W (the transporting height) exceeds a predetermined allowable range H, by use of the fact that the web is slacked when paper breakage of the web W occurs. When the transporting position of the web W is within the allowable range, it is considered as a normal printing state. The detection device 7 is configured of an out-of-range detection unit 71 and a paper breakage determination unit 72.

The out-of-range detection unit 71 detects whether or not the transporting position of the web W exceeds the allowable range H. The out-of-range detection unit 71 is configured of a distance sensor 20, a range setting part 30, and an out-of-range discrimination part 40. The distance sensor 20 is arranged below the web W being transported, and detects a distance to the web W. The range setting part 30 sets the allowable range H. The transporting position of the web W being transported is considered as a normal printing state when the transporting position is within the allowable range H. The out-of-range discrimination part 40 discriminates whether or not the distance detected by the distance sensor 20 exceeds the allowable range H. In the meantime, the paper breakage determination unit 72 determines paper breakage of the web W on the basis of the result of the discrimination by the out-of-range discrimination part 40.

Next, describing the range setting part 30 in detail, the range setting part 30 includes a reference distance setting portion 31, a relative upper limit distance setting portion 32 and a relative lower limit distance setting portion 33. The reference distance setting portion 31 sets a distance (a reference distance LR) from the web W being transported to the distance sensor 20. The relative upper limit distance setting portion 32 sets a relative distance (a relative upper limit distance LH>0) from the position of the web W being transported to the position of the upper limit of the allowable range H. The relative lower limit distance setting portion 33 sets a relative distance (a relative lower limit distance LL<0) from the position of the web W being transported to the position of the lower limit of the allowable range H.

The range setting part 30 also includes a reference distance storing portion 34, a relative upper limit distance storing portion 35 and a relative lower limit distance storing portion 36, respectively for storing the reference distance LR, the relative upper limit distance LH and the relative lower limit distance LL, which are set by the aforementioned setting portions 31, 32 and 33, respectively. The range setting part 30 further includes a calculating portion 37. The calculating portion 37 calculates the upper limit value (LR+LH) and the lower limit value (LR+LL) of the allowable range H on the basis of the reference distance LR, the relative upper limit distance LH and the relative lower limit distance LL, stored respectively in these storing portions 34, 35 and 36.

Through an unillustrated interface, printing speed signals of the web rotary printing press 1 are always input to the reference distance setting portion 31, and distance signals transmitted from the distance sensor 20 are also input thereto. Moreover, the reference distance setting portion 31 is configured to write, when the printing speed reaches to a predetermined value at which the transporting of the web W becomes stable, a distance detected by the distance sensor 20 at this printing speed into the reference distance storing portion 34, as the reference distance LR.

It should be noted that it is also possible to employ a configuration in which without causing distance signals from the distance sensor 20 to be always input to the reference distance setting portion 31, a distance signal from the distance sensor 20 is to be input to the reference distance setting portion 31 for the first time when the printing speed reaches a predetermined value at which the transporting of the web W becomes stable. In this configuration, the reference distance setting portion 31, then, writes this input value from the distance sensor 20 as the reference distance LR into the reference distance storing portion 34. Here, the predetermined value at which the transporting of the web W becomes stable is set in the reference distance setting portion 31 in advance, and the printing speed may be considered as this mechanical speed, or the plate cylinder speed, or the like.

The relative upper limit distance setting portion 32 and the relative lower limit distance setting portion 33 are configured of a push-button type or dial type input device, or a keyboard or the like, which is provided in the operation panel of the web rotary printing press 1. Moreover, as the input system, an interactive input system allowing a user to input values while viewing a CRT monitor may be employed.

The calculation portion 37 is configured as follows. The calculation portion 37 reads the reference distance LR, the relative upper limit distance LH and the relative lower limit distance LL, respectively from the reference distance storing portion 34, the relative upper limit distance storing portion 35 and the relative lower limit distance storing portion 36. The calculation portion 37 calculates the upper limit value (LR+LH) and the lower limit value (LR+LL) of the allowable range H on the basis of the reference distance LR, the relative upper limit distance LH and the relative lower limit distance LL. Then, the calculation portion 37 transmits the results of the calculation to the out-of-range discrimination part 40.

Next, describing the out-of-range discrimination part 40, the out-of-range discrimination part 40 includes an upper limit value storing portion 41 and a lower limit value storing portion 42 respectively for storing the upper limit value (LR+LH) and the lower limit value (LR+LL), each transmitted from the calculation portion 37. The out-of-range discrimination part 40 also includes an out-of-range determination portion 43 which determines whether or not the distance detected by the distance sensor 20 exceeds the allowable range H.

The out-of-range determination portion 43 is configured as follows. The out-of-range determination portion 43 reads the upper limit value (LR+LH) and the lower limit value (LR+LL) from the upper limit value storing portion 41 and the lower limit value storing portion 42, respectively. Furthermore, distance signals transmitted from the distance sensor 20 are input to the out-of-range determination portion 43 through an unillustrated interface at a constant frequency. Then, the out-of-range determination portion 43 discriminates whether or not the transporting position of the web W exceeds the allowable range H by determining whether or not each of the distances detected by the sensor 20 at the constant frequency is within a range between the upper limit value (LR+LH) and the lower limit value (LR+LL).

Next, describing the paper breakage determination unit 72, on the basis of the result of discrimination by the out-of-range discrimination part 40, the paper breakage determination unit 72 determines that printing is in a normal state in a case where the distance detected by the distance sensor 20 is within the range between the upper limit value (LR+LH) and the lower limit value (LR+LL), that is, in a case where the distance is within the allowable range H. On the other hand, the paper breakage determination unit 72 determines that paper breakage of the web W has occurred in a case where the distance detected by the distance sensor 20 exceeds the range between the upper limit value (LR+LH) and the lower limit value (LR+LL). The paper breakage determination unit 72, thus, outputs a failure process signal. Then, this failure process signal is transmitted to the drive motor for the printing press and the air cylinder 16.

It should be noted that each of the reference distance setting portion 31, the reference distance storing portion 34, the relative upper limit distance storing portion 35, the relative lower limit distance storing portion 36, the calculation portion 37, the upper limit value storing portion 41, the lower limit value storing portion 42, the out-of-range determination portion 43 and the paper breakage determination unit 72 is configured of a central processing unit, such as a microcomputer, various memories each connected to the central processing unit, and the like.

Accordingly, by employing the aforementioned configuration, air is blown from the air blowing device 6 towards the web W when the operation of the web rotary printing press 1 begins. Moreover, as the detection operation by the detection device 7 begins, the drive roller 13 is rotationally driven. In the meantime, the relative upper limit distance LH and the relative lower limit distance LL are respectively input to and set in the relative upper limit distance storing portion 32 and the relative lower distance limit storing portion 33 in advance.

Next, the distances detected by and transmitted from the distance sensor 20 are input to the reference distance setting portion 31 at a constant frequency. Then, when the printing speed of the web rotary printing press 1 reaches a predetermined value (for example, 200 rpm mechanical speed), the detected distance input at this time is written as the reference distance LR into the reference distance storing portion 34. Then, the calculation portion 37 calculates the upper limit value (LR+LH) of the allowable range H by adding the relative upper limit distance LH to the reference distance LR. The calculation portion 37 also calculates the lower limit value (LR+LL) of the allowable range H by adding the relative lower limit distance LL to the reference distance LR.

Thereafter, the distances detected by and transmitted from the distance sensor 20 are input to the out-of-range determination portion 43 at a constant frequency. Then, it is determined whether or not each of the input detected distances is greater than the upper limit value (LR+LH), or is smaller than the lower limit value (LR+LL). Then, in a case where the detected distance is not greater than the upper limit value (LR+LH), and is not smaller than the lower limit value (LR+LL), it is determined that paper breakage has not occurred, and the detection device 7 continues the detecting operation. On the other hand, in a case where the detected distance is greater than the upper limit value (LR+LH), or is smaller than the lower limit value (LR+LL), the paper breakage determination unit 72 determines that the web W is not transported at a height within the allowable range H. That is, the paper breakage determination unit 72 determines that the paper breakage has occurred. Accordingly, the paper breakage determination unit 72 outputs a failure process signal.

Here, since air of high temperature is swiftly blown towards the web W by the dryer 3, paper breakage of the web W often occurs in the dryer 3. Accordingly, in this embodiment, it is assumed that paper breakage of the web W being transported in the dryer 3 has occurred at point C (refer to FIG. 1) of the web W. At this time, the web W which has been cut is thus separated into a web w1 on the upstream side of the transporting direction with respect to the point C, and a web w2 on the downstream side of the transporting direction with respect to the point C.

When paper breakage occurs, since air of the air blowing device 6 has already been blown to the web w2, the height of the web w2 forcibly exceeds the allowable range H as indicated by the dashed dotted line in FIG. 3. For this reason, in a case where paper breakage has occurred, it is possible to cause the web w2 to promptly exceed the allowable range H. Accordingly, a period of time until the paper breakage is detected from the time when the paper breakage occurs can be shortened.

Then, as has been described, in a case where the paper breakage occurs at the point C, and then, the paper breakage determination unit 72 determines that the paper breakage has occurred, a failure process signal is output from the paper breakage determination unit 72 to the drive motor for the printing press and the air cylinder 16. Once this failure process signal is output, the drive motor for this printing press stops, and in the meantime, the swing arm 14 is caused to swing downward towards the web w1. That is, the web rotary printing press 1 is caused to stop, and the moving roller 12 is brought into contact with the drive roller 13 with the web w1 interposed therebetween.

When the moving roller 12 is brought into contact with the drive roller 13 with the web w1 interposed therebetween, the web w1 abuts the drive roller 13 while being pressed towards the drive roller 13. In the meantime, the moving roller 12 is caused to be rotated by the drive roller 13. Accordingly, the web w1 is discharged towards an area below the discharge device 5 as indicated by the dashed dotted lines in FIG. 2. Thereby, although the web w1 is transported by the printing unit 1 even after the paper breakage has occurred, the web w1 is continuously discharged by the rotation of the drive roller 13. Accordingly, it is possible to prevent the web w1 from being wound around the circumferential surface of, the cylinder such as the blanket cylinders 8, the plate cylinders 9 or the like, or of the roller of the inking device.

It should be noted that although the air blowing device 6 is arranged above the web W being transported in this embodiment, the air blowing device 6 may be arranged below the web W. In the meantime, although the detection device 7 is arranged below the web W being transported, the detection device 7 may be arranged above the web W. Furthermore, although the chill roller 11 which is driven and then rotates is employed, a chill roller which is caused to rotate (to follow and rotate along with) by the web W being transported may be employed. Such a chill roller can also provide tension to the web W.

Thus, according to the web detection device of the printing press of the present invention, the detection device 7 is provided in a vicinity of the chill roller 11 between the dryer 3 and the cooling device 4. Moreover, it is detected by the detection device 7 that the position of the web W (w2) which has been cut in the web surface crossing direction exceeds the allowable range H. Thereby, paper breakage can be stably and promptly detected.

That is, in a case where a detection device is provided on the upstream side in the web transporting direction of a dryer as in a conventional case, the amplitude in the web surface crossing direction of the web becomes larger by the blowing of hot air from the upper and lower directions by a drying portion. In contrast to this case, in the case where the detection device 7 is provided in the vicinity of the cooling device 4 on the upstream side in the web transporting direction of the dryer 3, not only the influence due to the blowing of hot air from the upper and lower directions by the drying portion 10 is no longer present, but also the amplitude in the web surface crossing direction of the web W due to the tension of the web W which occurs by being wound around the chill roller 11 can be suppressed. Accordingly, since the allowable range H can be set smaller, paper breakage can be stably and promptly detected. Then, when the web W exceeds the allowable range H, the web W which has been cut can be always detected. This makes it possible to prevent a web W which has not been cut from being wrongly detected.

Moreover, by providing the air blowing device 6 in the vicinity of the detection device 7 so that air is caused to be always blown towards the web W (w2) being transported, the air is blown to the web W having tension increased by being wound around the chill roller 11. Accordingly, the amplitude in the web surface crossing direction can be further suppressed, and in the meantime, the web w2 which has been cut is stably and promptly caused to exceed the allowable range H. In addition, a period of time until the failure process to be executed from the time when the paper breakage has occurred can be reduced to a large extent.

Moreover, since the air blowing device 6 is provided in the vicinity of the cooling device 4 on the downstream side in the web transporting direction of the dryer 3, the web W which has been kept under a high temperature can be cooled down. As a result, the printing quality can be improved. Furthermore, since the air blowing device 6 is arranged above the web W being transported, the direction of air blow can be the same as the direction of gravitational force. Accordingly, the web W (w2) which has been cut can be caused to exceed the allowable range H earlier.

Moreover, the discharge device 5 is provided between the printing unit 2 and the dryer 3. Then, the web W (w1) which has been cut, and which is to be transported to the side of the dryer 3 is caused to be forcibly discharged in a direction different from the direction towards the dryer 3 when it is detected that the web W (w2) which has been cut exceeds the allowable range H. Accordingly, it is possible to prevent the web w1 which has been cut from being wound around the cylinders, such as the blanket cylinders 8, the plate cylinders 9 or the like, or the roller of the inking device.

The present invention can be applied to a web detection device of a printing press in which paper breakage of a web can be detected in a short period of time, and in the meantime, the web which has been cut is prevented from being wound around on parts of the printing press.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A web detection device of a printing press, comprising:
a printing unit which prints on a web being transported;
drying means, which is provided on a downstream side in a web transporting direction of the printing unit, and which dries the printed web;
a rotating part, which is provided on a downstream side in the web transporting direction of the drying means, and around which the dried web is wound; and
detection means, which is provided in a vicinity of the rotating part, and which detects that a position of a web in a web surface crossing direction exceeds an allowable range.

2. The web detection device of a printing press according to claim 1, further comprising:
blowing means, which is provided in a vicinity of the detection means, and which always blows air to a web being transported.

3. The web detection device of a printing press according to claim 2, wherein the blowing means is provided above the web being transported.

4. The web detection device of a printing press according to claim 3, wherein the detection means is provided below the web being transported.

5. The web detection device of a printing press according to claim 1, further comprising:
discharge means, which is provided between the printing unit and the drying means, and which discharges a part of a web being transported from the printing unit to the drying means side in a direction different from a direction towards the drying means side when the detection means detects that the web has exceeded the allowable range.

6. The web detection device of a printing press according to claim 1, further comprising:
discharge means, which is provided between the printing unit and the drying means, and which pulls out a part of a web from the printing unit when the detection means detects that the web has exceeded the allowable range.

7. The web detection device of a printing press according to any one of claims 5 and 6, wherein
the discharge means includes:
a drive roller, which is provided on one side of the web being transported, and which is rotationally driven; and
a moving roller capable of moving in an area between a position at another side of the web being transported and a position at which the moving roller comes into contact with the driving roller with the web interposed therebetween, and wherein
when the detection means detects that the web exceeds the allowable range, the discharge means causes the moving roller to move so that the moving roller comes into contact with the drive roller with the web interposed therebetween.

8. The web detection device of a printing press according to claim 7, wherein
the drive roller is provided below the web being transported, and
the moving roller is provided above the web being transported.

9. The web detection device of a printing press according to claim 1, wherein the rotating part is a roller, which is rotationally driven, and which provides tension to a web being transported.

10. The web detection device of a printing press according to claim 1, wherein the rotating part is a chill roller which cools the web dried by the drying means.
